(19) United States
(12) Patent Application Publication
(10) Pub. No.: US 2025/0128602 A1
(43) Pub. Date: Apr. 24, 2025

(54) Method for Operating an Operator Control Element, and Operator Control Element

(71) Applicant: Bayerische Motoren Werke Aktiengesellschaft, Muenchen (DE)

(72) Inventors: Stefan BREITSCHAFT, Nabburg (DE); Thomas Hilger, Iffeldorf (DE); Christian Knoll, Muenchen (DE); Stephan Mueller, Muenchen (DE); Hannes Trapp, Muenchen (DE)

(21) Appl. No.: 18/919,562

(22) Filed: Oct. 18, 2024

(30) Foreign Application Priority Data
Oct. 20, 2023 (DE) 10 2023 128 969.1

(51) Int. Cl. B60K 35/25; G06F 3/01; G06F 3/0485; G06F 3/0488

(52) U.S. Cl. CPC B60K 35/25; G06F 3/016; G06F 3/0485; G06F 3/0488; B60K 2360/113; B60K 2360/1468

(57) ABSTRACT

A method is provided for operating an operator control element provided for a display device of a motor vehicle, wherein the display device is configured to display a list with at least one end, and wherein the operator control element is configured to output a control signal to the display device, which control signal is used to scroll through the displayed list, depending on a predetermined actuation of said actuator control element. The method determines whether the at least one end of the list has been reached by way of the predetermined actuation of the operator control element. The method prevents an output of a predetermined active haptic feedback signal by way of the operator control element only if it has been determined that the at least one end of the list has been reached by way of the predetermined actuation of the operator control element, or outputs a predetermined active haptic feedback signal by way of the operator control element only if it has been determined that the at least one end of the list has been reached by way of the predetermined actuation of the operator control element.

### CROSS REFERENCE TO RELATED APPLICATION

This application claims priority under 35 U.S.C. § 119 from German Patent Application No. DE 10 2023 128 969.1, filed Oct. 20, 2023, the entire disclosure of which is herein expressly incorporated by reference.

### BACKGROUND AND SUMMARY

The present disclosure relates to a method for operating an operator control element provided for a display device of a motor vehicle, to an operator control element, and to a motor vehicle having the operator control element.

Traditionally, operator control elements for motor vehicles are embodied as individually suspended and guided buttons. Operating feedback is purely mechanical and depends on the mechanical elements used, such as springs and silicone domes, etc. Pressing a button therefore always results in haptic operating feedback, even if the function assigned to the button is not usable, such as in the case of a functionless “telephone” button which may also be installed, under certain circumstances, in automobiles that are not equipped with a telephone connection for reasons of variant minimization. In addition, operator control units with pressably suspended panels that have a plurality of buttons are known in the prior art. The position of the finger on the panel is evaluated in this case and the corresponding function, which is stored at the selected location, is triggered. In this case, too, operating feedback is purely mechanical and therefore independent of whether or not the function can be executed.

In addition, multifunction operator control devices with active haptics are also known in the prior art and are described, for example, in DE 10 2017 127 231 A1.

Furthermore, in the case of a mechanical operator control element for operator control of digital lists (for example rotary-push actuator), haptic feedback can be output to a user of the mechanical operator control element when the end of a list has been reached, for example by increasing the operator control force or blocking the operator control element, said haptic feedback communicating to the user when the end of the list has been reached.

Against the background of this prior art, the object of the present disclosure is to provide a device and/or a method which are suitable for enhancing the prior art.

The object is achieved by the features of the independent claims. The content of each of the dependent claims is an optional development of the disclosure.

Accordingly, the object is achieved by a method for operating an operator control element provided for a display device of a motor vehicle. The display device is configured to display a list with at least one end. The operator control element is configured to output a control signal to the display device of the motor vehicle, which control signal is used to scroll through the displayed list, depending on a predetermined actuation of said actuator control element. The method comprises determining whether the at least one end of the list has been reached by means of the predetermined actuation of the operator control element. The method comprises preventing an output of a predetermined active haptic feedback signal by means of the operator control element only if it has been determined that the at least one end of the list has been reached by means of the predetermined actuation of the operator control element. As an alternative, the method comprises outputting a predetermined active haptic feedback signal by means of the operator control element only if it has been determined that the at least one end of the list has been reached by means of the predetermined actuation of the operator control element.

The control method may be a computer-implemented method, that is to say one, several or all steps of the method can be carried out at least in part by a computer or a device for data processing, optionally the control device.

“Active haptic” can mean that a haptic feedback signal is not or at least not exclusively provided by passive mechanical elements, such as return springs and/or silicone domes, but rather by an active actuator which can be controlled accordingly. In other words, in order to provide an active haptic feedback signal, it may be necessary to provide an actuator in the operator control element and to suitably control the actuator. For example, the actuator may comprise a piezoelectric actuator or be designed as such. Alternatively or additionally, the actuator may have other common actuator types, such as solenoids and/or voice coils.

A haptic feedback signal is a haptically perceptible event that can be output to the user. In particular, a haptic feedback signal can be output when the operator control element is actuated, on the basis of which signal successful actuation of the operator control element can be identified. The haptic feedback signal may optionally comprise a vibration, a pulse, a vibration pattern and/or a deflection. The haptic feedback signal may optionally be accompanied by an acoustic signal.

In order to determine whether the predetermined end of the list has been reached, the method may comprise determining an actuation of the operator control element. This may include determining that the operator control element has been touched. This may be advantageous in particular for operator control elements which have a touch operator control surface for example. In this case, determining an actuation of the operator control element may optionally include determining a position at which the operator control element has been touched, optionally a change in this position and furthermore optionally a speed and/or acceleration of the change in the position. Depending on the position, optionally the speed and/or the acceleration of the change in the position, it is then possible to evaluate the extent to which the display of the list is to be changed for bringing about or for operator control of the scrolling through the list.

The actuation of the operator control element may include or consist of an intended execution of a swipe process or a swipe movement, for example by means of a finger of the user, over an (upper) surface of the operator control element provided for this purpose. This surface of the operator control element may consequently be configured as a touch-sensitive surface or as a touch operator control surface.

Scrolling can be understood to mean a moving of screen contents (both text and graphics). The purpose is to display an extensive amount of content in a limited space. The swipe movement can be effected for scrolling. In addition or as an alternative, the scrolling to move screen contents may include, for example, highlighting individual entries of the list in color.

The list may be a table with a plurality of rows and/or columns. The individual entries may be rows of the list arranged vertically one below the other and spaced apart from one another. The individual entries may be columns of the list arranged horizontally next to one another and spaced apart from one another. Consequently, the scrolling may be effected horizontally and/or vertically. The predetermined end may be the last entry of the list horizontally on the right and/or on the left. The predetermined end may be the last entry of the list vertically at the top and/or at the bottom.

The operator control element and/or the display device may be part of a human-machine interface of the motor vehicle. The operator control element may comprise a control device which outputs the control signal to the display device. For example, the control device may be an electronic control unit (ECU). The electronic control unit may be an intelligent processor-controlled unit, which can communicate with other modules of the motor vehicle, for example via a central gateway (CGW), and which may form the vehicle on-board electrical system by means of field buses, such as the CAN bus, LIN bus, MOST bus, FlexRay and/or via the automotive Ethernet, for example together with telematics control units and/or an environmental sensor system. For the driving behavior of the motor vehicle, in addition to the operator control element and the display device, the control device may control relevant functions, such as the steering, the engine control, the power transmission and/or the braking system. In addition, driver assistance systems, such as a parking assistance system, adaptive cruise control (ACC), a lane keep assistance system, a lane change assistance system, a traffic sign recognition system, a light signal recognition system, a start-up assistance system, a night vision assistance system and/or an intersection assistance system, for example, can be controlled by the control device. In other words, in addition to the operator control element and the display device, the control device can also control other functions or modules of the motor vehicle.

Outputting the active haptic feedback signal means that an event is initiated and can be perceived haptically by the user on the operator control element. This may include outputting control signals to an actuator of the operator control element, for example by means of the control device described above, such that the actuator causes a haptically perceptible movement of the operator control element.

The disclosure provides, inter alia, the advantage that the reaching of the start and/or end of a list can be signaled to a user of the motor vehicle in a manner clear and imperceptible for operator control, that is to say for example without the driver having to avert his gaze from the driving situation. Thus, the disclosure avoids distraction of the user. This can be achieved on the one hand by passively signaling to the user the reaching of the end of the list to the extent that an output of the active haptic feedback signal is omitted despite further operator control of the operator control element. This can be achieved on the other hand by actively signaling to the user the reaching of the end of the list to the extent that a characteristic active haptic feedback signal is output when the end of the list has been reached.

Possible further developments of the method described above are explained in detail below.

If the method comprises preventing the output of the predetermined active haptic feedback signal by means of the operator control element only if it has been determined that the at least one end of the list has been reached by means of the predetermined actuation of the operator control element, the method may include outputting the predetermined active haptic feedback signal by means of the operator control element if it has been determined that the at least one end of the list has not been reached by means of the predetermined actuation of the operator control element.

In other words, as soon as the end of the list has been reached, individual entry feedback may no longer be output and so the end of the list is implicitly displayed. In the case of a purely mechanical operator control element, this would correspond to a mechanical stop or a braked/blocked operator control element.

The list may have a plurality of individual entries, wherein the predetermined active haptic feedback signal can be output by means of the operator control element in each case for each or for a plurality of the individual entries which have been reached by means of the scrolling.

In other words, as described above, scrolling can be understood to mean a scrolling process in which new individual entries are continuously displayed by means of the display device as a result of the scrolling process. It is conceivable that the predetermined active haptic feedback signal is output for each newly displayed individual entry. The same applies to the case in which, although no new individual entry is displayed by the scrolling, a new or another individual entry is highlighted. In this case, it is not necessary for the active haptic feedback signal to be output individually for each individual entry, but it is also possible, for example, for it to be output only for each X-th newly displayed or highlighted individual entry (that is to say with X really greater than 1).

A frequency of the output of the predetermined active haptic feedback signal by means of the operator control element can be effected depending on a length of the list, a speed of the predetermined actuation and/or depending on a length of the predetermined actuation.

In other words, depending on the speed of the predetermined actuation, optionally a single swipe movement, and/or depending on the length of the predetermined actuation, optionally a distance of a single swipe movement, can be determined, whether the active haptic feedback signal is output individually for each new individual entry (that is to say with X=1) or whether said active haptic feedback signal is output only for each X-th newly displayed or highlighted individual entry (that is to say with X really greater than 1). The magnitude of X can consequently vary depending on the speed and the distance. It is conceivable that a length of the list, optionally a number of individual entries on the list, is also additionally or alternatively taken into account here. In other words, depending on the list design, a different translation from the swipe path to the number of incremented individual entries can be realized. Furthermore, provision may be made for this translation to be adapted depending on the speed of the gesture execution, optionally the acceleration.

If the method comprises outputting the predetermined active haptic feedback signal by means of the operator control element only if it has been determined that the at least one end of the list has been reached by means of the predetermined actuation of the operator control element, it is conceivable that the method may include outputting a further predetermined active haptic feedback signal by means of the operator control element if it has been determined that the at least one end of the list has not been reached by means of the predetermined actuation of the operator control element.

In other words, it is thus possible to actively signal not only the end of the list, but also that the end of the list has not yet been reached.

The predetermined active haptic feedback signal may be output by means of the operator control element in addition to the further predetermined active haptic feedback signal being output by means of the operator control element if it has been determined that the at least one end of the list has been reached by means of the predetermined actuation of the operator control element.

In other words, as soon as the end of the list is swiped away, although further individual entry feedback can be output, the active haptic element may output additional haptic feedback which advises of the end of the list. This corresponds to an unbraked rotary knob, supplemented by a soft stop.

In this case, too, the list may have a plurality of individual entries, wherein the further predetermined active haptic feedback signal can be output by means of the operator control element in each case for each or for a plurality of the individual entries which are achieved by means of the scrolling.

Likewise, a frequency of the output of the further predetermined active haptic feedback signal by means of the operator control element can be effected depending on a speed of the predetermined actuation and/or depending on a length of the predetermined actuation.

The predetermined actuation may be a swipe gesture.

The swipe gesture may also be referred to as a swipe movement. The swipe gesture can be understood to mean swiping for example with one or more fingertips over the operator control element to control the display device, optionally the displayed content thereof.

The disclosure furthermore relates to an operator control element for a display device of a motor vehicle. The display device is configured to display a list with at least one end. The operator control element is configured to output a control signal to the display device of the motor vehicle, which control signal is used to scroll through the displayed list, depending on a predetermined actuation of said actuator control element. The operator control element is configured to determine whether the at least one end of the list has been reached by means of the predetermined actuation of the operator control element. The operator control element is configured to prevent an output of a predetermined active haptic feedback signal by means of the operator control element only if it has been determined that the at least one end of the list has been reached by means of the predetermined actuation of the operator control element. As an alternative, the operator control element is configured to output a predetermined active haptic feedback signal by means of the operator control element only if it has been determined that the at least one end of the list has been reached by means of the predetermined actuation of the operator control element.

What has been described above with reference to the method also applies analogously to the operator control element and vice versa.

The disclosure furthermore relates to a motor vehicle, wherein the motor vehicle comprises the operator control element described above and a display device connected thereto, wherein the display device is configured to display a list with at least one end.

The display device may comprise a screen for displaying the list. The display device may comprise or constitute a head-up display, by means of which the list can be displayed.

The motor vehicle may be a passenger vehicle, in particular an automobile, or a commercial vehicle, such as a truck, for example.

What has been described above with reference to the method and to the operator control element also applies analogously to the motor vehicle and vice versa.

Furthermore, a computer program comprising commands which, when the program is executed by a computer, cause the computer to execute or carry out at least in part the method described above, may be provided.

A program code of the computer program may be present in any code, in particular in a code which is suitable for controlling motor vehicles.

Furthermore, a computer-readable medium, in particular a computer-readable storage medium, may be provided. The computer-readable medium comprises commands which, when the commands are executed by a computer, cause the computer to execute or carry out at least in part the method described above.

This means that a computer-readable medium which comprises a computer program defined above may be provided. The computer-readable medium may be any digital data storage unit, such as a USB stick, a hard drive, a CD-ROM, an SD card or an SSD card (or SSD drive/SSD hard drive), for example.

The computer program does not necessarily have to be stored on such a computer-readable storage medium in order to be made available to the vehicle, but may also be obtained via the Internet or otherwise externally.

What has been described above with reference to the method, to the operator control element and to the motor vehicle also applies analogously to the computer program and to the computer-readable medium and vice versa.

It is understood that the features and embodiments mentioned above and explained below should not only be considered disclosed in the combinations explicitly mentioned in each case, but that other technically meaningful combinations and embodiments are also included in the disclosure content.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle;

FIG. 2 schematically shows an operator control element according to the disclosure and a display device connected thereto, which are each suitable for installation in the motor vehicle; and

FIG. 3 schematically shows a flowchart of a method according to the disclosure for operating the operator control element.

The same reference signs are used for the same or similar elements in the figures. In the descriptions of the figures, reference signs are sometimes stated, even though the respective element may only be able to be seen in other figures.

### DETAILED DESCRIPTION OF THE DRAWINGS

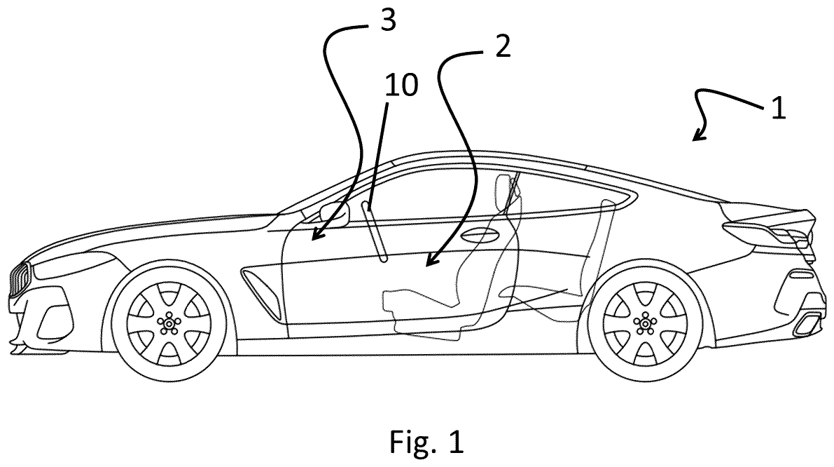

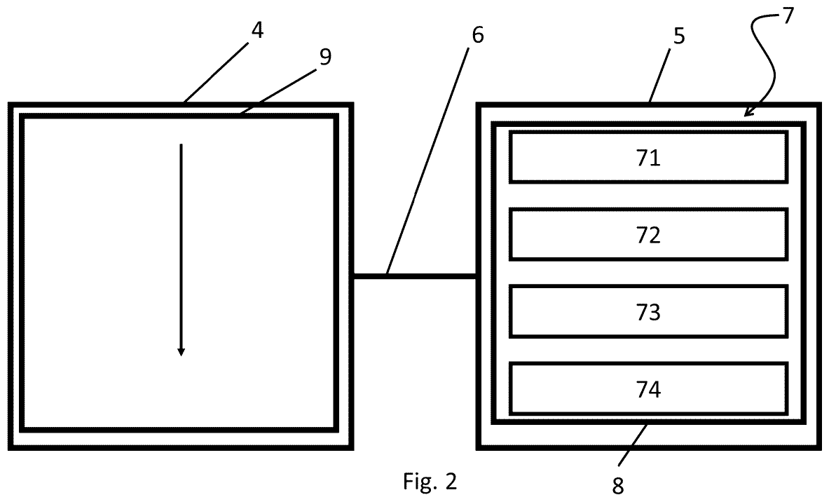

FIG. 1 schematically illustrates, by way of example, a side view of a motor vehicle 1 in the form of an automobile, which has, for example, the operator control element 4 schematically illustrated in FIG. 2 in the region 2 of a center console and the display device 5 schematically illustrated in FIG. 2 in the region 3 of a dashboard. In addition or as an alternative, the operator control element 4 may be arranged on a steering wheel 10 of the motor vehicle 1.

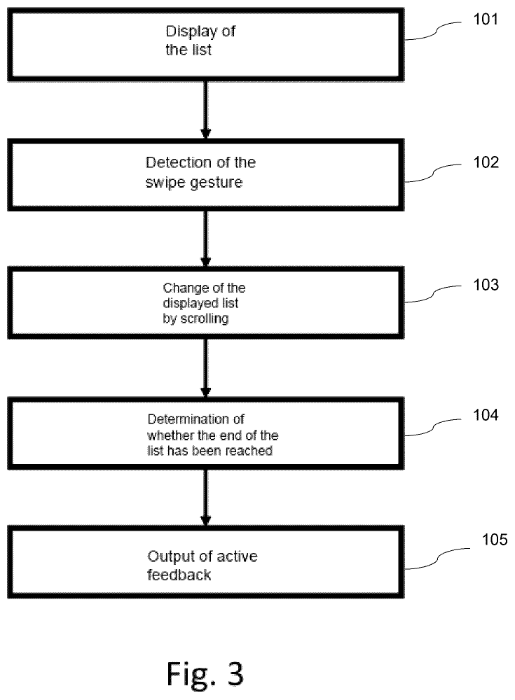

As can be seen from the schematic illustration in FIG. 2, the operator control element 4 is connected to the display device 5 via a data line 6. The operator control element 4 and the display device 5 are configured to be operated in accordance with the method 100 also described below with reference to FIG. 3.

In a first step 101 of the method 100, the display device 5 displays, by means of a screen 8, a list 7, which in turn has a plurality of list entries or individual entries 71-74 (wherein only four entries are illustrated here by way of example). In the first step 101, a first individual entry 71, which in this case is arranged vertically at the upper edge of the screen 8, is highlighted in color with respect to the other individual entries 72-74. This highlighted individual entry 71 marks a start or a first or upper end of the list 7. The fourth individual entry 74 arranged here vertically at the lower edge of the screen 8 marks a second or lower end of the list 7.

In a second step 102 of the method, a swipe gesture at the operator control element 4 from top to bottom, symbolized by the arrow in FIG. 2, via a touch-sensitive surface 9 of the operator control element 4 is ascertained or identified. This swipe gesture from top to bottom corresponds to a predetermined actuation of the operator control element 4, which causes the operator control element 4 to output a control signal to the display device 5 via the data line 6, the control signal being used to scroll through the displayed list 7.

In a third step 103 of the method 100, another individual entry 72-74, which is arranged below the uppermost individual entry 71, is highlighted to implement the scrolling, brought about by the received control signal. Which of the other individual entries 72-74 is highlighted depends in the present case on a length of the list 7 (for example determined by the number of individual entries 71-74 of the list 7), a speed of the swipe gesture and/or a length of the swipe gesture. It is thus contemplated that a jump is made directly to the last of the individual entries 74 in the case of a relatively fast and/or long swipe gesture, or that a jump is made to the next of the individual entries 72 in the case of a relatively slow and/or short swipe gesture.

The second and third steps 102, 103 of the method 100 are performed continuously, such that a repeated performance of the swipe gesture can be used to scroll through the list 7. Once the lower end of the list 7, that is to say the last individual entry 74, has been reached, a further swipe gesture in the third step 103 does not (optionally: further) change the display of the screen 8.

In parallel with the above-described output of the control signal to the display device 5 in the second step 102 of the method, the operator control element 4 is used in a fourth step 104 of the method 100 to check or to determine whether the lower end of the list 7, that is to say the last individual entry 74, has been reached or is currently highlighted. This serves to determine whether and, if so, what active haptic feedback signal should be output by the operator control element 4 in a fifth step 105 of the method 100, which is executed in parallel with or at the same time as the third step 103 of the method 100.

If, in the fourth step 104 of the method 100, it is determined that the end of the list or, in this case, the list entry 74 has not yet been reached as a result of the scrolling (see steps 102 and 103), then, in the fifth step 105, a predetermined active haptic feedback signal is output by means of the operator control element 4. This is performed for each of the individual entries 72-74, which are reached by means of the scrolling. That is to say, if, for example, the last individual entry 74 is scrolled to directly on account of the speed and/or the length of the swipe gesture, the operator control element outputs the predetermined active haptic feedback signal once in the fifth step 105. However, in the case of scrolling to each of the further individual entries 72, 73, for example, until the last individual entry 74 has been reached on account of the speed and/or the length of the swipe gesture, in the fifth step 105, the operator control element outputs the predetermined active haptic feedback signal once for each of the individual entries 72, 73 (that is to say the active haptic feedback signal is output twice until the last individual entry 74 has been reached).

If, however, in the fourth step 104 of the method 100, it is determined that the end of the list or, in this case, the list entry 74 has been reached as a result of the scrolling (see steps 102 and 103), then there are fundamentally two alternatives for outputting the active haptic feedback signal in the fifth step 105. According to a first alternative, an output of the predetermined active haptic feedback signal by means of the operator control element 4 is prevented, that is to say an active haptic feedback signal is no longer output. It is thus signaled to the user that the end of list 7 has been reached. According to a second alternative, the operator control element 4 is used to output a predetermined active haptic feedback signal which differs from the active haptic feedback signal described above and which was output when the individual entries 72-73 were reached and thus before the end of the list was reached. This other active haptic feedback signal can be output in addition to or as an alternative to the feedback signal which was output when the individual entries 72-73 had been reached and thus before the end of the list had been reached. In this way too, it is possible to signal to the user that the end of the list has been reached. However, both alternatives are carried out only or exclusively when it has been determined in the fourth step 104 that the at least one end of the list, in this case the lower end, or the individual entry 74 has been reached by means of the predetermined actuation of the operator control element 4, that is to say the swipe gesture.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle
2 Region of the center console
3 Region of the dashboard
4 Operator control element
5 Display device
6 Data line
7 List
71-74 Individual entries on the list
8 Screen
9 Touch pad or touch-sensitive surface
10 Steering wheel
100 Method
101 Display of the list
102 Detection of the swipe gesture
103 Change of the displayed list by scrolling
104 Determination of whether the end of the list has been reached
105 Output of active haptic feedback

What is claimed is:

1. A method for operating an operator control element provided for a display device of a motor vehicle,
wherein the display device is configured to display a list with at least one end, and
wherein the operator control element is configured to output a control signal to the display device, which control signal is used to scroll through the displayed list, depending on a predetermined actuation of said actuator control element, and
wherein the method comprises:
determining whether the at least one end of the list has been reached by way of the predetermined actuation of the operator control element; and
(i) preventing an output of a predetermined active haptic feedback signal by way of the operator control element only when it has been determined that the at least one end of the list has been reached by way of the predetermined actuation of the operator control element, or
(ii) outputting a predetermined active haptic feedback signal by way of the operator control element only when it has been determined that the at least one end of the list has been reached by way of the predetermined actuation of the operator control element.

2. The method according to claim 1, wherein when the method prevents the output of the predetermined active haptic feedback signal by way of the operator control element only when it has been determined that the at least one end of the list has been reached by way of the predetermined actuation of the operator control element,
the method further comprises:
outputting the predetermined active haptic feedback signal by way of the operator control element when it has been determined that the at least one end of the list has not been reached by way of the predetermined actuation of the operator control element.

3. The method according to claim 2, wherein
the list has a plurality of individual entries,
the predetermined active haptic feedback signal is output by way of the operator control element in each case for each or for a plurality of the individual entries which have been reached by way of the scrolling.

4. The method according to claim 3, wherein
a frequency of the output of the predetermined active haptic feedback signal by way of the operator control element is effected depending on a speed of the predetermined actuation, and/or depending on a length of the predetermined actuation.

5. The method according to claim 1, wherein when the method outputs the predetermined active haptic feedback signal by way of the operator control element only when it has been determined that the at least one end of the list has been reached by way of the predetermined actuation of the operator control element,
the method further comprises:
outputting a further predetermined active haptic feedback signal by way of the operator control element when it has been determined that the at least one end of the list has not been reached by way of the predetermined actuation of the operator control element.

6. The method according to claim 5, wherein
the predetermined active haptic feedback signal is output by way of the operator control element in addition to the further predetermined active haptic feedback signal being output by way of the operator control element when it has been determined that the at least one end of the list has been reached by way of the predetermined actuation of the operator control element.

7. The method according to claim 5, wherein
the list has a plurality of individual entries,
the further predetermined active haptic feedback signal is output by way of the operator control element in each case for each or for a plurality of the individual entries which have been reached by way of the scrolling.

8. The method according to claim 7, wherein
a frequency of the output of the further predetermined active haptic feedback signal by way of the operator control element is effected depending on a length of the list, a speed of the predetermined actuation, and/or depending on a length of the predetermined actuation.

9. The method according to claim 1, wherein the predetermined actuation is a swipe gesture.

10. A control element for a display device of a motor vehicle, wherein the display device is configured to display a list with at least one end, comprising:
an operator control element configured to output a control signal to the display device, which control signal is used to scroll through the displayed list, depending on a predetermined actuation of said actuator control element,
wherein the operator control element is further configured to determine whether the at least one end of the list has been reached by way of the predetermined actuation of the operator control element; and
wherein the operator control element is further configured to:
(i) prevent an output of a predetermined active haptic feedback signal by way of the operator control element only when it has been determined that the at least one end of the list has been reached by way of the predetermined actuation of the operator control element, or
(ii) output a predetermined active haptic feedback signal by way of the operator control element only when it has been determined that the at least one end of the list has been reached by way of the predetermined actuation of the operator control element.

11. A motor vehicle, comprising:
a display device configured to display a list with at least one end; and
the control element according to claim 10.
